(19) United States
(12) Patent Application Publication
(10) Pub. No.: US 2004/0198236 A1
(43) Pub. Date: Oct. 7, 2004

(54) Wireless telephone jack

(76) Inventors: Scott Paine, Center Harbor, NH (US); Renee Cartier-Paine, Center Harbor, NH (US)

Correspondence Address: Bourque & Associates, P.A., 835 Hanover Street, Suite 301, Manchester, NH, 03104, US

(21) Appl. No.: 10/231,848

(22) Filed: Aug. 30, 2002

(51) Int. Cl. H04B 1/40; H04Q 7/20; H04M 1/00; H04B 1/38

(52) U.S. Cl. 455/74.1; 455/426.1; 455/554.1

(57) ABSTRACT

A wireless telephone outlet method and system is described, having a base unit connected to a telephone line, which base unit is in wireless two-way communication with a remote unit. The remote unit has a telephone jack connectable to a telephony device, at which jack the remote unit replicates the incoming state of the telephone line sensed by the base unit and communicated to the remote unit. The base unit replicates the incoming state of the telephone jack sensed by and communicated to the base unit by the remote unit. The operation is transparent to the devices which may be interconnected in this manner.

### TECHNICAL FIELD

The present invention relates to wireless telephony and more particularly, to wireless telephone jacks.

### BACKGROUND INFORMATION

Wireless telephony is well known in the art. Cellular phones, wireless portable phones and even wireless computer networks are ubiquitous. With wireless networks, a user may move from room to room with his or her laptop computer, all the while remaining connected to the local area network. If the network is provided with internet access, the network connection could also provide internet access to the wirelessly connected device.

It is often the case that a user may wish to have a POTS (plain old telephone service) connection with a standard (RJ-11) telephone outlet available at a location where one cannot be found. For example, a user not having a network internet connection may wish to connect a laptop computer modem to a POTS line for access to the internet.

It is known to provide wireless telephone jacks using the AC power distribution system in a building. For example, Bullock et al (U.S. Pat. No. 6,107,912) teaches using a power line data communication device designed to transfer data over the AC power lines. Using such a system, a telephone jack can be had anywhere there is a power outlet by plugging in a remote communication device which connects over the AC power line to a second device connected both to the power line and to the POTS line. Such devices are limited in that they still require that a remote device be connected to a device plugged into a power line, and are hence limited in their portability and mobility.

It is also known to construct circuits able to detect various conditions on a POTS line, such as ring, dial tone, off hook and busy, and respond automatically to such signals. For example, both facsimile machines and modems have such capability. If a facsimile machine is used to initiate a call to send a fax, it sets the POTS line to off-hook (OH) and detects the presence of a dial tone. If a dial tone is not detected within a set period, an error condition results, otherwise a telephone number is sent over the POTS line using, e.g., dual tone multi-frequency tones (DTMF). The facsimile machine will wait either for a busy signal, at which it will terminate the call, or tone from a receiving facsimile machine. If it receives the tone, the fax is transmitted and the end of the call, the facsimile machine sets the POTS line to On hook. Circuitry known in the art to accomplish each of these steps, as well as other steps, so as to be able to automate a telephone call, are well known in the art.

While portable telephones which communicate with a local base station connected to a POTS line are able to be used without a direct physical connection between the remote unit and the base station, they do not offer a telephone jack to be used with other devices that is, they do not provide a remote and mobile source of “dial tone”.

Cellular phones frequently have special adapters to permit their use with computer modems, but are much slower that POTS service connections, are generally expensive to use, and require special hardware to make the connection between a modem and the cellular phone, which device is unusable with other types of telephone connectable devices, such as a fax. These devices also naturally require that cellular service be available.

### SUMMARY

The present invention provides a general purpose wireless telephone jack system and method having the same functionality as a POTS telephone outlet, with the additional feature of wirelessly connecting to the POTS line. In effect, it provides a two way mirror: what is sensed at a POTS line is transmitted to a remote unit connector to a telephony device; and what is sensed coming from the telephony device is transmitted to the POTS line. In one embodiment, a base unit is connected to a POTS line, the state of which can be sensed and transmitted to a remote unit. The remote unit is able to sense the state of a telephone outlet (which may be an RJ-11 jack) connected to the remote unit, into which a telephony device may be connected, and to communicate this state to the base unit.

In another embodiment, the remote unit is able to sense an off-hook state at the outlet, and to communicate this to the base unit that in response sets the POTS line to off-hook. The base unit is able to sense the presence of a dial tone, and to communicate this to the remote unit, which in turn is able to present a dial tone at the outlet. Similarly, the base unit can detect a ring signal and communicate this to the remote device that is then able to present a ring signal at the outlet.

The remote unit is connectable to a telephony device, such as a telephone handset or a modem or other similar device which communicates over a telephone line. In another embodiment, the communications link between the base unit and the remote unit is secure, such as by encrypted/decrypted transmission.

### BRIEF DESCRIPTION OF THE DRAWINGS

These and other features and advantages of the present invention will be better understood by reading the following detailed description, taken together with the drawings wherein:

FIG. 1 is a block diagram of a wireless telephone outlet system in accordance with the teachings of the present invention; and

FIG. 2 is a flow chart of a wireless telephone outlet method in accordance with the present invention.

### DETAILED DESCRIPTION OF THE PREFERRED EMBODIMENTS

The present invention provides for a wireless POTS line communication to a telephony device using a POTS line. The telephony device may be a telephone, a modem, a facsimile machine, a modem or other such device which uses a POTS telephone line for communications. The present invention uses a base unit which is connected to a POTS line (either directly or indirectly, such as by using a wireless AC line outlet communications device to connect with the POTS line) and which communicates the state of the incoming POTS line to a remote unit.

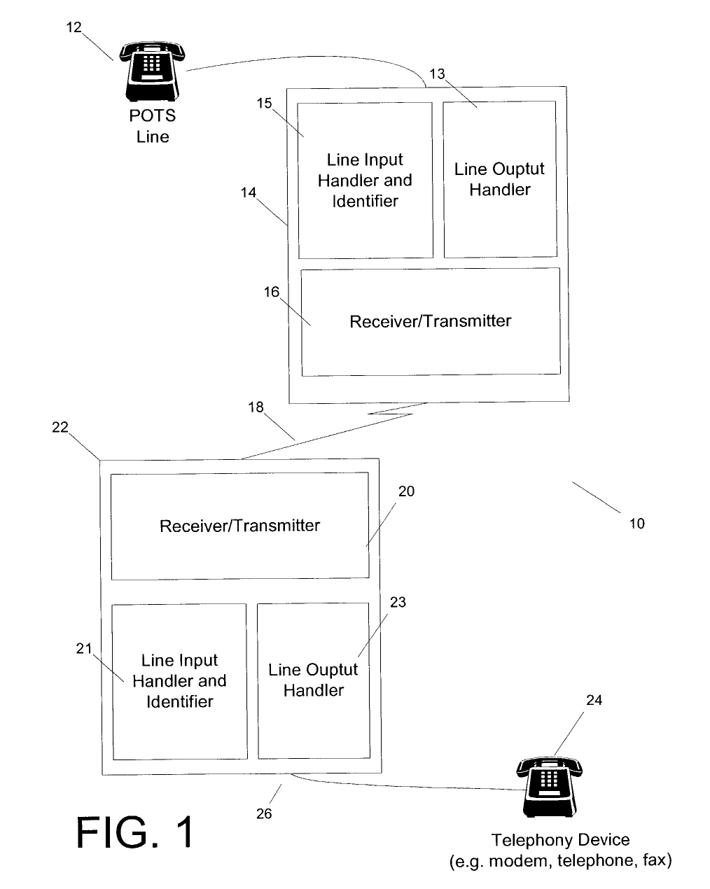

With reference to FIG. 1, a block diagram of an embodiment of a wireless telephone outlet 10 is shown. A POTS line 12 is connected (or placed in communication with) a base unit 14. This connection may be by direct-wired connection, or by any of known means of wireless connection such as through the AC power system, cable line, wireless, etc. The base unit 14 has a line input handler and identifier section 15 which senses the state of the incoming POTS line and, using a receiver/transmitter 16, communicates that state over a wireless link 18 to a remote unit 22 also having a second receiver/transmitter 20. Line output handler 23 converts the information received from the receiver/transmitter into telephony signals. The remote unit 22 may have a telephone outlet jack 26, such as an RJ-11 jack, through which the remote unit may be connected to an external telephony device 24. In another embodiment (not shown) the remote unit may be built in to the external telephony device, such as being combined with a telephone handset. The handset in turn may have a telephone outlet jack connected to the remote unit.

When the remote unit 22 is on, it communicates with the base unit 16. The base unit senses and communicates the present state of the POTS line to the remote unit over the wireless link 18, which converts the received signal into a telephony signal using line output handler 23. In turn, the remote unit 22 senses the state of the output jack 26 (or telephony device of which it is a part) through line input handler and identifier 21 and communicates this state over the wireless link 18 to the base unit 16, which, using the receiver transmitter 16 and line output handler 13, replicates this state at the POTS line connection 12. In effect, the base unit and remote unit act in tandem (as far as the POTS line 12 and telephony unit 24 are concerned) as an ordinary phone jack.

For example, the telephony device may be a modem attempting to initiate a telephone call. The base unit 16 would first present dial tone to the remote unit 22. The modem would present an off-hook condition at the outlet jack 26, which condition would be then communicated by the remote unit 22 over the wireless link 18 using the receiver/transmitters 20 and 16. The base unit would then replicate the off-hook condition at the POTS line connection 12.

Similarly, the state if the POTS line connection 12 is sensed by the base unit 16, and communicated over the wireless link 18 to the remote unit 22 using the receiver/transmitters 16 and 20. In the present example, having set the POTS line to an off-hook condition, in most cases a dial tone would be presented at the POTS line connection. Whatever the state of the POTS line connection (with or without a dial tone) is transmitted to the remote unit 22 and presented at the connection 26 to the telephony device 24, in this case a modem.

If the modem senses a dial tone present, the process continues as the modem places the call. The state of the incoming POTS line is communicated by the base unit to the remote unit, then to the connector 26, and virtually simultaneously, the state of the incoming connector is communicated by the remote unit to the base unit and presented to the outgoing POTS line.

As may be seen, the POTS line 12 and the telephony device 24 need have no modifications to utilize the wireless telephone jack. The telephony device 24 sees a normal telephone signal at the connector 26.

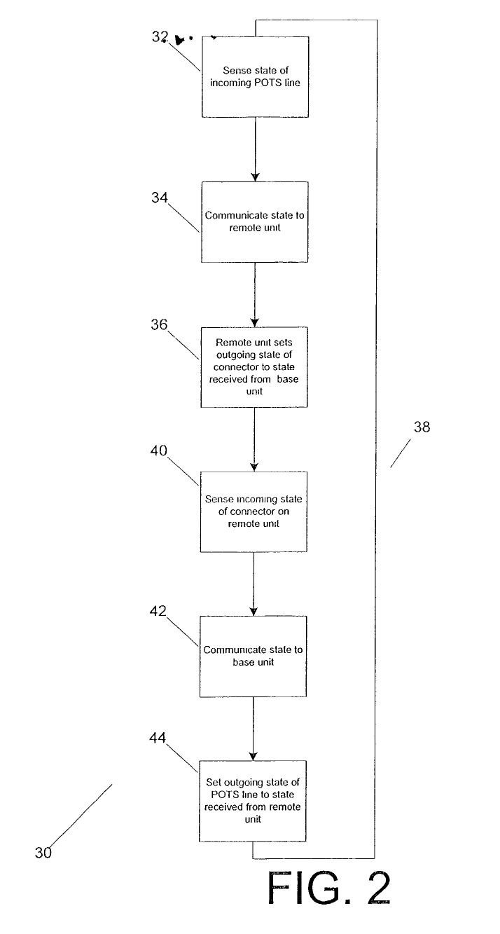

With reference to FIG. 2, a flowchart of a method 30 of providing a wireless outlet is shown. A base unit 16 senses 32 the incoming state at the POTS line 12, and communicates this state wirelessly 34 over the communication link 18 to a remote unit 22. The remote unit 22 sets the outgoing state 36 of the outlet jack 26 to the state it has received from the base unit 16. (This state may be by way of interpretation, such as by converting to digital signal for transmission and converting the digital signal back to an analog signal at the point of reception.)

Virtually simultaneously, a remote unit 22 senses, at 40, the incoming state of the outlet jack 26, receives and presents this communicated state 42 to the base unit 16, which in turn replicates the state 44 at the outgoing POTS line 12.

This process continues 38 endlessly as long as the base unit and remote unit are turned on. While it is showhn as a sequence of steps, the sensing, transmitting and replication at both the base unit 16 and remote unit 22 goes on continuously and virtually simultaneously so long as one or both units 16 and 22 are turned on.

Both the POTS line 12 and the remote unit connection 26 operate in the same manner as an ordinary telephone connection, the entire process of sensing, transmitting, receiving and replicating being transparent to the POTS line 12 and to the telephony device 24.

The remote device may be incorporated into a telephony device, such as a wireless telephone, which may also have a telephone jack. Thus, a user may have the benefit of a wireless telephone as well as a wireless telephone device connection for use with a computer, fax or other telephony device.

Modifications and substitutions by one of ordinary skill in the art are considered to be within the scope of the present invention, which is not to be limited except by the following claims.

The invention claimed is:

1. A wireless telephone outlet comprising:
a base unit wirelessly coupled to a remote unit;
said base unit connected to a POTS line and having a transmitter capable of sending and receiving signals from and to said remote unit, and further capable of sensing at least a first state of the POTS line and wirelessly sending said at least a first state to said remote unit;
said remote unit having a transmitter capable of wirelessly sending and receiving telephone type signals to and from the base unit and further having a connector adapted to receive a mating plug from an external device, and further able to sense a second state at the connector and communicate said second state to the base unit; and
wherein said remote unit configured so as to receive the first state from the base unit and replicate said first state at the connector, and the base unit configured so as to receive the second state from the remote unit and replicate said second state at the POTS line.

2. The wireless telephone outlet of claim 1 wherein the connector comprises an RJ-11 outlet.

3. The wireless telephone outlet of claim 1 wherein the remote unit is able to detect an off-hook condition at the connector, and communicate this state to the base unit, and wherein the base unit, responsive to an off hook condition communicated from the remote unit, goes into an off hook condition at the POTS connection.

4. The wireless telephone outlet of claim 3 wherein the base unit is able to detect the presence of a dial tone at the POTS connection and communicate this state to the remote unit, and wherein the remote unit, responsive to the dial tone condition communicated from the base unit, is able to provide a dial tone to the connector of the remote unit.

5. The wireless telephone outlet of claim 4 wherein the base unit is further able to detect a ring signal at the POTS line and, responsive to a ring signal, communicate with the remote unit which, responsive to the communicated ring signal, provides a ring signal to the connector of the remote unit.

6. The wireless telephone outlet of claim 1 wherein the remote unit is connected with a second device.

7. The wireless telephone outlet of claim 6 wherein the second device comprises a telephone handset.

8. The wireless telephone outlet device of claim 6 wherein the second device comprises a modem.

9. The wireless telephone outlet of claim 1 further comprising means for providing secure communications between the base unit and the remote unit.

10. The wireless telephone outlet of claim 1 wherein the condition of the POTS line is sensed and communicated by the base unit to the remote unit which places the connector in the same condition as the POTS line; and
wherein the condition of the connector is sensed by and communicated to the base unit which places the POTS line in the same condition as the outlet.

11. The wireless telephone communications device of claim 9 wherein the means for secure communications comprises encrypting and decrypting a signal exchanged between the base unit and the remote unit.

12. A method of remote telephony comprising the acts of:
providing a base unit having a transmitter and receiver, and which is connected to a POTS line;
providing a remote unit having a transmitter and a receiver capable of communicating with the base unit;
providing an outlet on the remote unit connectable to a telephony device which is capable of being connected to a POTS line; and
connecting the telephony device to the outlet, and initiating a telephone call over the POTS line using the remote unit in communication with the base unit to convey telephone signals.

13. The method of claim 12 further comprising the acts of detecting the presence of a ring signal at the POTS line and communicating the presence of a ring signal at the POTS line to the remote unit, and wherein the remote unit, in response to the communicated ring signal, provides a ring signal at the connector of the remote unit.

14. The method of claim 12 further comprising the acts of detecting an off hook connection at the outlet, communicating the presence of the off hook condition to the base unit, and in response to the communicated off-hook condition, the base unit providing an off hook condition to the POTS line.

15. The method of claim 14 further comprising the acts of detecting a dial tone at the POTS line, communicating the dial tone condition to the remote unit, and the remote unit providing a dial tone to the connector of the remote unit.

16. A system for a wireless telephone outlet comprising a base unit connected to a POTS line and having a transmitter and receiver for communicating wirelessly with a remote unit;
the remote unit having a transmitter and receiver for communicating with a base unit and an outlet connectable to a telephony device;
the remote unit and base unit being adapted to transmit and receive telephony signals;
the base unit being configured so as to be able to sense a first state of the POTS line and to communicate said state to the remote unit which can replicate said first state at the outlet;
the remote unit being configured so as to be able to sense a second state at the input and to communicate said second state to the base unit can replicates said second sate at the POTS line; and
the base unit being configured so as to be able to initiate, and terminate a telephone call in response to signals transmitted from the remote unit.

17. The system of claim 16 wherein the base unit is configured so as to set an off hook condition at the POTS line in response to an off hook condition communicated from the remote unit.

18. The system of claim 16 wherein the remote unit, responsive to a ring condition communicated from the base unit, provides a ring signal at the outlet.
